(19) United States
(12) Patent Application Publication
(10) Pub. No.: US 2006/0285705 A1
(43) Pub. Date: Dec. 21, 2006

(54) COAXIAL SPEAKER

(76) Inventor: Byong Yong KONG, Icheon-shi (KR)

Correspondence Address: IPLA P.A., 3580 WILSHIRE BLVD., 17TH FLOOR, LOS ANGELES, CA, 90010, US

(21) Appl. No.: 11/419,853

(22) Filed: May 23, 2006

(30) Foreign Application Priority Data
Jun. 21, 2005 (KR) 10-2005-0053573

(51) Int. Cl. H04R 25/00

(52) U.S. Cl. 381/182

(57) ABSTRACT

A coaxial speaker is provided. The speaker includes a bottom plate; a tweeter; a pole having a through-hole passing up/down at its upper and central part; and a tweeter fixing member fixed and connected at its one end to a bottom surface of the tweeter, and fixed and connected to an upper end of the bottom plate through the through-hole of the pole.

### BACKGROUND OF THE INVENTION

1. Field of the Invention

The present invention relates to a coaxial speaker, and more particularly, to a coaxial speaker for preventing diffraction of sound, thereby improving a response characteristic of a reproduced sound.

2. Description of the Related Art

FIG. 1 illustrates a construction of a conventional coaxial speaker. A construction and an operation of the conventional coaxial speaker will be described below with reference to FIG. 1.

The conventional speaker includes a bottom plate 1, a pole 2, a voice coil 3, a permanent magnet 4, a frame 5, a vibration plate 6, a tweeter 7, a bobbin 8, and a fixing support 9 for fixing the tweeter 7.

In the conventional speaker, its operation principle is based on a Fleming's left hand rule. In detail, a direction of a magnetic field generated from the permanent magnet 4 provided at the speaker and a direction of current flowing through the voice coil 3 cause left and right vibration of the bobbin 8 attached to the voice coil 3, and the left and right vibration of the bobbin 8 causes up and down vibration of the vibration plate 6, and the up and down vibration of the vibration plate 6 causes vibration of air, thereby being converted into a sound energy heard by person's eyes. In the sound energy, a reproduced sound is different in band depending on a size of the vibration plate 6. Further, as the vibration plate 6 is larger in size, it is more effective to reproduce a low-band sound. As the vibration plate 6 is smaller in size, it is more effective to reproduce a high-band sound. Accordingly, the coaxial speaker is divided, depending on the band of the reproduced sound, into three parts: a high-band reproduction part, a middle-band reproduction part, and a low-band reproduction part. The high-band reproduction part is called “tweeter”, the middle-band reproduction part is called “mid-range”, and the low-band reproduction part is called “woofer”. The high-band reproduction part corresponds to the tweeter 7, and the middle-band and low-band reproduction parts correspond to the vibration plate 6.

Accordingly, each part of the speaker has a difference in the band of the reproduced sound and therefore, three parts should be adapted in property and used to effectively reproduce a whole band. Therefore, a sound source should be formed on one axis in order to have an effective property.

Accordingly, in the conventional speaker, the tweeter 7 reproducing the high-band sound is fixed in front by the fixing support 9, and the vibration plate 6 is provided under the fixing support 9 in order to form one axis with the tweeter 7 to the maximum.

However, in the conventional speaker, the tweeter 7 is provided in front, and the fixing support 9 fixing the tweeter 7 is provided and therefore, the reproduced sound generated by the vibration of the vibration plate is diffracted by the fixing support 9.

As described above, the conventional coaxial speaker has a drawback in that diffraction of the reproduced sound generated by the vibration plate is caused by the fixing support fixing the tweeter and therefore, a response characteristic of the reproduced sound is deteriorated.

### SUMMARY OF THE INVENTION

Accordingly, the present invention is directed to a coaxial speaker that substantially overcomes one or more of the limitations and disadvantages of the conventional art.

One object of the present invention is to provide a coaxial speaker in which, owing to absence of a fixing support fixing a speaker tweeter, diffraction of sound can be prevented, thereby improving a response characteristic of a reproduced sound.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a coaxial speaker including: a bottom plate; a tweeter; a pole having a through-hole passing up/down at its upper and central part; and a tweeter fixing member fixed and connected at its one end to a bottom surface of the tweeter, and fixed and connected to an upper end of the bottom plate through the through-hole of the pole.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a conventional coaxial speaker; and

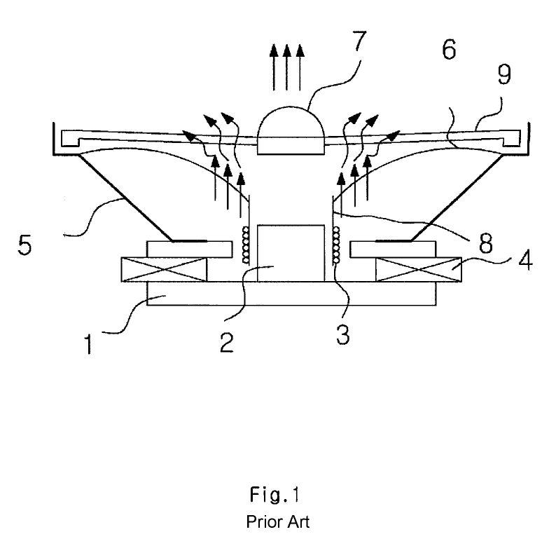

FIG. 2 illustrates a construction of a coaxial speaker according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

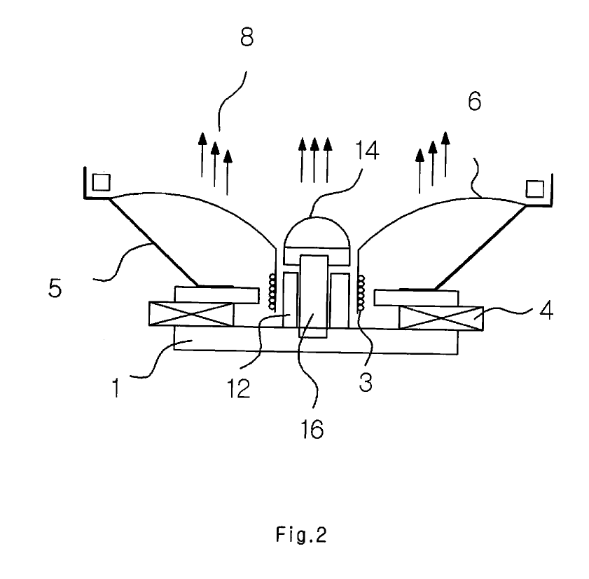

FIG. 2 illustrates a construction of a coaxial speaker according to the present invention. Hereinafter, a construction and an operation of the coaxial speaker according to the present invention will be described with reference to FIG. 2.

The inventive coaxial speaker includes a bottom plate 1, a pole 12, a voice coil 3, a permanent magnet 4, a frame 5, a vibration plate 6, a tweeter 14, and a tweeter fixing member 16.

In the present invention, the tweeter 14 is fixed by the pole 12 and the tweeter fixing member 16. The pole 12 has a through-hole passing up/down at its upper and central part. The tweeter fixing member 16 is fixed and connected at its one end to a bottom surface of the tweeter 17, and is fixed and connected to an upper end of the bottom plate 1 through the through-hole of the pole 12. It is desirable that a length of the tweeter fixing member 16 forms one axis with the vibration plate 6.

As described above, the present invention has an advantage in that, owing to absence of a fixing support fixing the tweeter in front of the coaxial speaker, diffraction of a reproduced sound can be prevented, thereby improving a response characteristic of the reproduced sound.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A coaxial speaker comprising:
a bottom plate;
a tweeter;
a pole having a through-hole passing up/down at its upper and central part; and
a tweeter fixing member fixed and connected at its one end to a bottom surface of the tweeter, and fixed and connected to an upper end of the bottom plate through the through-hole of the pole.
